(19) United States
(12) Patent Application Publication
(10) Pub. No.: US 2004/0015827 A1
(43) Pub. Date: Jan. 22, 2004

(54) Programming station generating a compacted program and automation equipment using such a program

(75) Inventors: Pascal Nicolle, Cagnes s/Mer (FR); Christian Tuccinardi, Golfe Ilian (FR); Bruno Bories, Le Cannet (FR)

Correspondence Address: PARKHURST & WENDEL, L.L.P., 1421 PRINCE STREET, SUITE 210, ALEXANDRIA, VA, 22314-2805, US

(73) Assignee: Schneider Automation, Valbonne (FR)

(21) Appl. No.: 10/073,217

(22) Filed: Feb. 13, 2002

(30) Foreign Application Priority Data
Feb. 19, 2001 (FR) 01 02303

(51) Int. Cl. G06F 9/44

(52) U.S. Cl. 717/104; 717/106

(57) ABSTRACT

This invention relates to a programming station comprising a memory containing description files, each description file describing part of an automation application and being expressed in a single, hierarchised and object oriented language such as the XML language. The programming station uses a compression program that generates a file in the compacted format stored in a memory on the automation equipment, for each description file. The compression program comprises a step to reduce tags contained in a description file by applying a specific stylesheet and a step to execute a compaction algorithm adapted to XML files.

This invention relates to a programming station generating a compacted program using a single hierarchised and object oriented language to program an automation application and automation equipment using such a program.

In the following, a programming station refers to computer equipment, particularly a PC type personal computer, that can be connected to an automation equipment. In the following, automation equipment refers to a programmable logic controller, an instrumentation/control station, a numerical control or other equipment that can contain and execute an application program controlling an automation application. For example, this automation application may be in the domain of industrial process automation, building automation or instrumentation/control of electrical distribution networks.

This type of automation equipment is composed of a central unit and one or several input-output modules connected to sensors and preactuators of the automation application to be controlled.

The central unit comprises at least one processor, a non-volatile memory, usually not modifiable (ROM) or modifiable (EEPROM) containing the manufacturer's program also called the proprietary operating system, expressed in a language specific to the manufacturer of the automation equipment, a RAM memory and an input-output manager communicating together through a back plane bus. A first area of the RAM memory (also called the volatile memory) contains the user's program, and a second area contains the data, and particularly images of the states of input-output modules and constants related to the user's program.

The user's program, also called the application program, monitors or controls an automation application by means of inputs-outputs controlled by this application program. The designer creates this program and it is written in one or several graphic automation languages particularly including Ladder Diagrams called Ladder language in the following, Sequential Function Charts or Grafcet language called SFC language in the following, Function Block Descriptions called FBD language in the following, or in IL (Instruction List) or ST (Structured Text) type automation text languages. These automation languages are preferably conform with standard IEC 1131-3 to facilitate programming by an automation designer who is not necessarily familiar with computer languages. These languages can be used on programming stations that may or may not be connected to the automation equipment to be programmed.

At the moment, application programs created using graphic automation languages conform with standard IEC 1131-3 cannot be exchanged between automation equipment made by different manufacturers with manufacturer programs based on different manufacturer languages and different programming workshops. After the designer of an automatic control has produced the application program in one of the standard languages, the programming station or the automation equipment on which the designer is working translates this program into a binary file dependent on the specific language of the manufacturer of each automation equipment. Only this file is stored in the automation equipment so that it can be executed by the automation equipment processor.

A third party connected to the automation equipment through a PC type programming station without a decompilation program on his station will be unable to understand the automation application program in binary format stored in the automation equipment and will not be able to make any modifications unless he has installed a plurality of programming programs specific to the manufacturer on his station (programming workshop). One solution would be to store the application program on the automation equipment in source language, but the size of this source program would often be incompatible with the memory size of the automation equipment.

The first purpose of the invention is to obtain a programming station using a single language that can be edited by any editor to generate automation application programs in a compacted format, regardless of the graphic language used to describe operation of the automation equipment.

This purpose is achieved using a station for programming an automation application designed to be executed in an automation equipment, the programming station comprising a memory containing a set of one or several description files, each description file describing a part of the application and being expressed in a single, hierarchised and object oriented language. The programming station uses a compression program that generates a file in the compacted format for each description file, the contents of the compacted file being sufficient for the description of the part of the application considered, and in that it uses a loading program to store each compacted file in a memory in the automation equipment.

According to one feature, the programming station uses a decompression program to generate a description file in a single, hierarchised and object oriented language describing part of the application, from a compacted file stored in the automation equipment memory.

According to another feature, the single, hierarchised and object oriented language is the XML (extended Markup Language) language.

According to another feature, the set of one or several description files contains an application program description file, an application input-output description file, and an application data description file.

According to another feature, the compression program comprises a step to reduce tags contained in a description file expressed in the XML language by application of a specific stylesheet and a step to execute a compaction algorithm adapted to XML files. The decompression program comprises a step to execute a decompaction algorithm adapted to XML files and a step to recreate source tags contained in a description file expressed in the XML language, by application of a specific stylesheet.

According to another feature, the programming station includes an XML handler (Hndlr) in a non-volatile memory dialoguing through notifications firstly with a management module of the tree structure representative of the automation application expressed in the XML language, and also with a plurality of database managers, each specific to part of the automation application stored in one of the databases.

Another purpose of the invention is to propose automation equipment capable of importing or exporting automation applications that it executes on a programming station on which an XML editor or display unit is installed.

This purpose is achieved by the fact that the automation equipment comprises a memory containing an automation application program in the form of a binary file executable by the automation equipment. The automation equipment stores the executable binary file in its memory, together with one or several files in a compacted format output from the description file(s), in which the contents are sufficient for a description of the application, starting from one or several description files describing all or part of the application and expressed in a single, hierarchised and object oriented language.

According to one feature, the single, hierarchised and object oriented language is the XML (eXtended Markup Language) language.

According to another feature, the automation equipment comprises translation means in order to convert application description files expressed in the XML language into a binary file that can be executed by the automation equipment.

According to another feature, the automation equipment comprises means of decompressing a file in compacted language to a description file in XML language, by using a specific stylesheet.

The proposed XML grammar can be used to define a single exchange format for the five graphic or text languages (LD, SFC, FBD, IL, ST) conform with standard IEC 1131-3. Automation application data will also be described in the XML language and thus can be easily imported or exported to different third party software (electrical CAD, Supervision, etc.).

XML language files will also be transformed into other XML language files with a different grammar, using a stylesheets mechanism (XSLT: eXtensible Stylesheet Language Transformation). For example, it will be very easy to make a gateway between data in an automation application and a spreadsheet software such as Microsoft Corporation's EXCEL.

Parts of applications generated in the XML language will be displayed by WEB search, display, edit utilities (browsers) such as Internet Explorer, which include XML display units in the basic version. Another advantage of the proposed solution is that it offers a formal grammar for exchanging automation data. Therefore, the solution proposed herein offers many advantages for exchanging automation data.

Other features and advantages of this invention will become clearer after reading the following description with reference to the appended drawings in which:

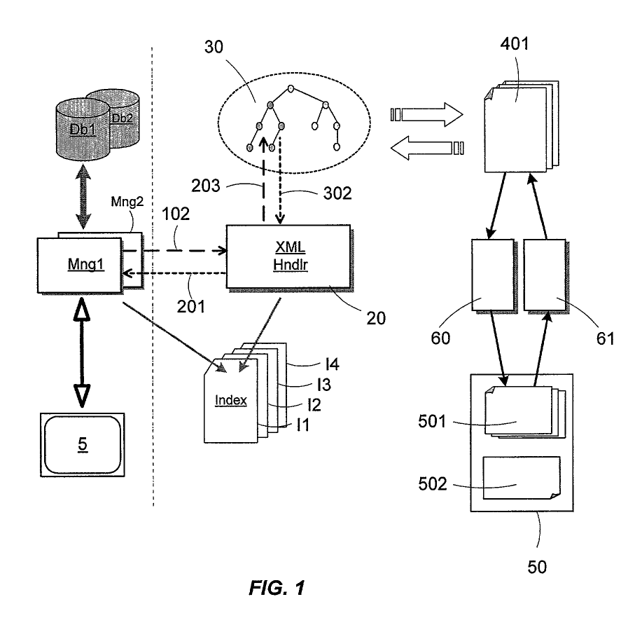

FIG. 1 shows a diagrammatic view of a programming station on which an XML manager is installed to import or export description files from a single language application to one of the graphic languages,

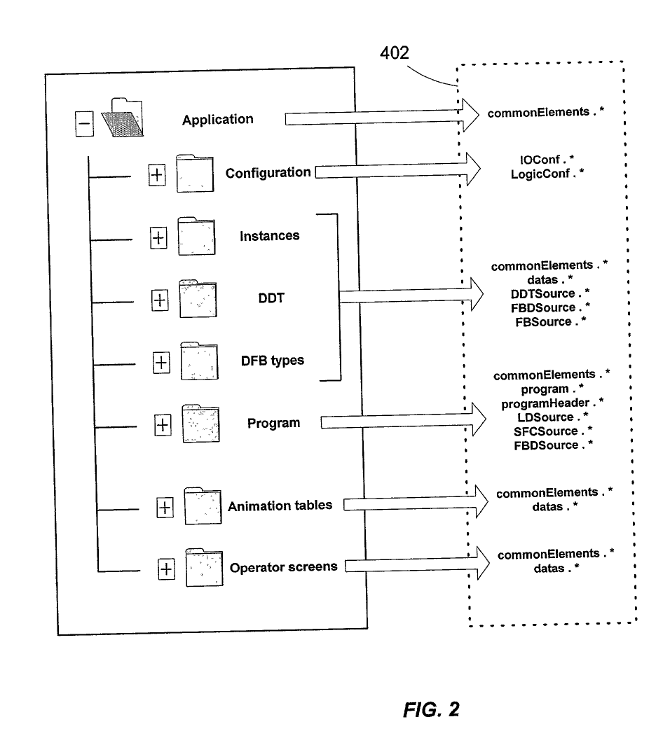

FIG. 2 shows an example of the memory organization of the grammar used to describe an automation application in the single language according to the invention,

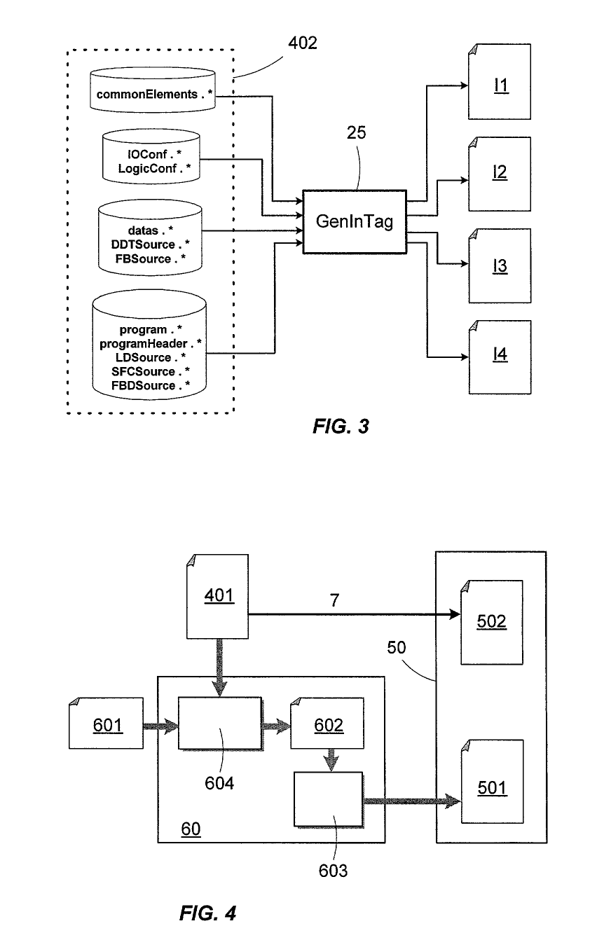

FIG. 3 shows a software component that forms a tag index generator to produce index files,

FIG. 4 shows details of the process for compression of a description file to a compacted file.

The invention consists of describing an automation application using a single, hierarchised and object oriented language starting from a grammar of this language defined specifically to translate the automation application written in one or several graphic automation languages conform with standard IEC1131-3 and to store a compacted file output from this description in the automation equipment. In the embodiment presented, this single, hierarchised and object oriented language may be the XML (eXtended Markup Language) language. The description is text only (no binary information). It is independent of the implementation and must respect XML standards. The XML description of an automation application may be stored in full or in part in the form of a set of one or several description files. These files may be imported and/or exported to and from third party software. Each descriptive object of the application in the XML language is assigned firstly XML tags that are words enclosed between “less than” (<) and “greater than” (>) signs, and also by attributes (in the form name=“value”). Therefore the entire application can be described using tags and attributes. The tags are only used to delimit data elements and the application that reads the data interprets these data completely. These tags are usually composed of words that are understandable even for a user who is not a person skilled in the art.

Normally an automation application is described by several description files comprising an application program description file, an application inputs-outputs description file, and an application data description file.

Appendix 1 contains one specific grammar for the translation of an application program description written in Ladder graphic language, into the XML language.

The description in the Ladder language is structured into contact networks, and each network is described line by line working from the top downwards. Each line is described from the left towards the right. Each line begins with the left rail (to the left of the view of the Ladder network) and terminates on the last graphic element described . Each line contains a list of standard graphic elements in the Ladder language: contacts, coils, horizontal link, vertical link, function block, etc. Graphic coordinates are relative to the position of objects in the table of rows and columns of a graphic display.

Line 10 in the grammar shown in appendix 1 corresponds to a graphic representation of an application in Ladder language, and defines that an “LDSource” application in Ladder is composed of a Ladder network (networkLD) and from zero to n (indicated by the * sign) text boxes (textBox) defined in lines 59 to 61. A Ladder network (networkLD) is composed of one or several type lines (typeLine) (indicated by the + sign) and a link with zero to n function blocks (FBLink). As described in line 50 in appendix 1, the link with at least one function block (FBLink) is composed of two position objects (objPosition), the coordinates of these position objects defining a start position corresponding to the “from” attribute (from, line 51) and an end position corresponding to the “to” attribute (to, line 52). As described in line 13 in appendix 1, the type line (typeLine) object is composed from zero to n of a combination of the following objects, either an empty line (emptyLine), or a contact (contact), a horizontal link (Hlink), a vertical link (Vlink), a coil (coil), a control (control), a short circuit (shortCircuit), an empty cell (emptyCell), a function block call (calls), an FFB expression (FFBExpression), a comparison block (compareBlock) and an arithmetic operation block (operateBlock), at will.

The type line (typeLine) object has a text label attribute. The attribute of the contact object defined on line 18 is the type of contact that defines the contact type, open, closed, upwards, downwards, in the form of an enumeration (openContact, closedContact, Pcontact, Ncontact) and the name of the contact variable (ContactVariableName) that is of type text. Line 23 defines the horizontal link (Hlink) object that has a number of cells (numberCell) through which the horizontal link (Hlink) passes, as an attribute. Lines 26 and 27 in appendix 1 define the coil (coil) object that can be either of type coil (Coil), inverse coil (not Coil), coil for setting to one (setCoil), reset coil (resetCoil), transition hash coil (hashCoil) used only in association with the SFC language, rising front coil (Pcoil), falling front coil (Ncoil) and the name of the coil variable (coilVariableName) that is of type text. The control object (control) defines the control type, either jump (jumpCoil) or return (retCoil) on lines 35 to 37. The short circuit object (shortcircuit) is defined on line 38 as being the combination of vertical link (Vlink) objects and one of the horizontal link (Hlink), contact, coil (coil), calls (calls), comparison block (compareBlock) elements at will. A call block (calls) as defined on line 39, contains an instance of an object (instanceObj), a parameter type (typeparam) and a call description (descriptionCall). The parameter type (typeParam) and the call description (descriptionCall) may or may not be assigned different values, since they are optional as indicated by the “?” sign. The value of the parameter type is defined on line 41 as being a boolean value equal to “0” or “1” (enEn0). Line 43 defines the description of a call (descriptionCall) as being composed of a list of inputs (inputListFBD) to the function block (FBD) that are lists of formal parameters and effective parameters (see lines 45 and 46) and a list of outputs (outputListFBD) from the function block (FBD). The text boxes are defined by the position of the text box object and by its dimensions in height and width.

For sections written in Ladder language, each application program may be described using the grammar corresponding to the Ladder graphic language. Each grammar is used to define a hierarchy between objects and to represent an automation application in the form of a graphic tree structure (30) in the programming station RAM memory.

Thus, as can be seen in appendix 1, the root of the tree is composed of the source application (LDSource) to which one or several sons are attached, namely the network (networkLD) and possibly one or several text boxes (textBox). The network has one or several sons composed of type line (typeLine) and FB link type (FBLink) objects. The line type (typeLine) object has a son consisting of the empty line (emptyLine), or one of the following elements: contact (contact), vertical link (Vlink), horizontal link (Hlink), coil (coil), control (control), short circuit (shortCircuit), calls (calls), comparison of blocks (compareBlock), execution of block (operateBlock), FFB expression (FFBExpression).

Appendix 2 defines a grammar specific to the translation of a description of an application in the SFC graphic language, into the XML language.

Line 11 of the grammar shown in appendix 2 defines that the description of an application (SFCSource) into the SFC language comprises a header (SFCHeader) and is structured into pages (SFCPage) that correspond to screen pages displayed by an SFC language editor. The header (SFCHeader) has the task (task) and the graph name (graphName) as attributes. Each page may contain one or several SFC networks (networkSFC). Each network contains a list of “object” elements chosen among the following standard graphic elements of the SFC language: step (step), jump (jump), transition (transition), link between steps and transition (SFCLinkobject), comment (commentSFC), link between graphs (linkSFC). The graphic coordinates of the different jump, step or transition type objects are defined by a position type object (objPosition) defining the row/column position of the corresponding object (jump, step or transition) in the table. A step type object (step) is defined by one or several actions in which the attributes are defined on lines 23 and 24 in appendix 2. Transitions are also defined by transition conditions (transitionCondition) on line 28. Link between graphs type objects (linkSFC) are composed of two position objects (objPosition), the coordinates of these position objects defining a start position corresponding to the “from an object type” (typeObjectFrom), line 45 attribute and an end position corresponding to the “to an object type” attribute (typeObjectTo), line 54. Each of these two attributes is chosen from one of the following objects: initial step (initialStep), step (step), macro step (macroStep), internal step (stepIn), transition (transition, A branch (Abranch), P branch (Pbranch), A joint (Ajoint), P joint (Pjoint), and for the “to” attribute, chosen from the previous objects and the jump object (jump).

The hierarchy of the SFC language is as follows. The root of the tree structure is the source object (SFCSource) that itself has the header (SFCHeader) and the page (SFCPage) as sons. The page has the network (networkSFC) as son, and the sons of the said network are the step (step), the jump (jump), the transition (transition), the SFC object link (SFCLinkObject), the SFC comment (commentSFC), and the SFC link between graphs (linkSFC).

Similarly, appendix 3 shows a grammar specific to the translation of a description of an application in an FBD graphic language into the XML language.

Each network in the FBD language contains a list of standard graphic elements in the FBD language: the function block (FFBBlock), text box (textboxFBD), label (labelObject), comment (commentobject FBD), link between blocks (linkFBD) and jump instruction (jumpObject). Each element is defined in accordance with lines 12 to 39 in appendix 3. The graphic coordinates are relative to the row/column position of objects in the table.

The hierarchy between objects defined in this grammar is as follows. The root is composed of the FBD source (FBDSource), which is composed of one or several FBD networks (networkFBD). Each network is composed of one or several of the following son elements: the block (FFBBlock), the text box (textBoxFBD), the label (labelObject), the jump (jumpObject), the comment (commentObjectFBD) and the link (linkFBD).

The grammar description files (402, FIG. 2) are organised as follows. An automation application may be broken down into three main parts, its program, its data and its inputs/outputs. According to the invention, the grammar of each of these parts is described in a “Document Type Definition” file in the “.dtd” format (for example program.dtd for the application program file, datas.dtd for the data file, IOConf.dtd for the inputs/outputs configuration file) or in a “Schematic” file in the “.xsd” format. In the following, we will talk about “.dtd” files but they may be replaced by “.xsd” files which are equivalent. Thus, when the “datas.*” type notation is used in FIGS. 2 and 3, it refers to a data file that may be either a “datas.dtd” or “datas.xsd” type file. Each part of the application program may itself be broken down into sub-parts each forming the subject of a “.dtd” (or “.xsd”) description file. For example, the program file (program.dtd) may include source files (LDSource.dtd, SFCSource.dtd and FBDSource.dtd, as shown in FIG. 3) that contain grammars of the different graphic automation languages of the Ladder diagram, sequential function chart (SFC) and function block (FBD) types.

“.dtd” and “.xsd” grammar files are files specific to the manufacturer and contain a description of the different grammars. Thus the “Application” file (FIG. 2) contains the (commonElements.*) file that contains elements common to the automation application, namely the application name, the production date of the application or the version, the version number and comments. The “Configuration” file contains configuration files for inputs/outputs (IOConf.*) and for the logical configuration (LogicConf.*) respectively. The “Instance”, “DDT”, “DFB types” files contain the description of data, instance, DDT, FB type in the form of (data, DDTSource.*, FBDSource.*, FBSource.*) files. The “Program” file contains the (LDSource.*, SFCSource.* and FBDSource.*) source files that contain the description of each grammar specific to each normal graphic language described in appendices 1 to 3 respectively. The “Animation tables” folder contains the description of animation tables, that includes the common elements (commonElements.*) and data (datas.*) files. The “Operator screens” folder contains descriptions of operation screens composed of common element (commonElements.*) and data (datas.*) files. These different grammar files of the “.dtd” type define the structure of XML files. An XML file of an application represents an instance of the grammar defined in the corresponding “.dtd” file. XML description files (401) are specific to the automation application considered. The principle of correspondence between these two types of files is defined by the XML standard V1.0 in accordance with the Document Object Model (DOM). The document object model DOM is a set of standard call functions for manipulating XML files, starting from the manufacturer's automation graphic languages.

Correspondence between XML files and application databases is as follows:

An automation application is stored in binary format on a programming station that can be connected to an automation equipment. This automation application according to prior art was developed by the user who used an editor (5) for graphic languages IEC 1131-3 using a software component subsequently called a manager (Mng1, Mng2, etc.) to store user inputs in several databases; for example one database (Db1) for the application program, one database (Db2) for application data and one database (Db3) for the configuration of application inputs/outputs, (Db1) and (Db2) being shown in FIG. 1. The description of the application in the XML language according to the invention is completely independent of its implementation in such manufacturers' databases. A particular software component has been developed in order to achieve this independence; this component forms an automatic tag index generator represented in FIG. 3 and is referred to in the following as the GenInTag (25) component.

The GenInTag software component (25) generating tag indexes must be executed to produce index files in order to make the correspondence between the XML graphic tree structure (30) representing the automation application in the language according to the invention, and database structures (Db1, Db2). This GenInTag component extracts keywords (elements and attributes) from the different files (402) that define XML (.“dtd”) grammars for the program, data, the input-output configuration in the XML language, in order to generate indexes organized in several files, for example four files (I1, I2, I3, I4) in FIG. 3, each containing one or several files of index constants used by the different managers (Mng1, Mng2, . . . ). The GenInTag component reads definition files for the document type “.dtd” or diagram type “.xsd”—and generates the different index files. These index files create the correspondence that makes it possible to use application description databases (Db1, Db2) according to prior art. They are stored in non-volatile memory on the programming station.

The programming station includes an XML Handler Hndlr (20) program in non-volatile memory. The XML handler Hndlr (20) is a software component developed in the C++ language that can be used through a COM interface. It encapsulates and uses the services of a DOM Parser Prsr and offers high level services for the management of the XML graphic tree structure (30). The XML Handler Hndlr (20) makes it possible for the programming station to create the tree structure (30) representative of the application from description files (401) using grammar files (402), or to create this structure starting from requests made by managers (Mng1, Mng2, . . . ) of application databases. It uses the different managers that call the services of the XML Handler Hndlr (20) using index files (I1 to I4) generated by the GenInTag component (25). As shown in FIG. 1, each part of an application, for example an application program (Db1), application data (Db2), is managed by a specific manager (for example Mng1 for the application program, Mng2 for the data). The XML Handler Hndlr (20) comprises the DOM Parser Psrs which is a software component in the C++ language, and also an export routine and an import routine.

The export routine writes the automation application information into an XML file, and the import routine reads the automation application information into an XML file. Each of the managers dialogs with the different services of the XML handler Hndlr (20). The specific managers (Mng1, Mng2, etc.) use index files (I1 to I4). In one advantageous variant of the invention, the export routine incorporates a compression program (60) to generate a compacted form (501) of the XML data file (401) once the XML file has been produced. The programming station then uses a loading program in order to store each generated compacted file (501) in the automation equipment memory (50).

Thus, due to its compacted form (501), the automation application in source language will occupy less memory space and it will be possible to load it entirely onboard the automation equipment, whereas in prior art it was impossible to load the entire application in source language onboard the automation equipment due to the amount of memory occupied by the application in the source language. Furthermore, as shown in FIG. 4, the compacted file (501) is stored in the memory (50) of the automation equipment at the same time as the binary data file (502) resulting from a conventional compilation of the XML file (401) by the programming station compiler (7). The file (502) output from this compilation can be used directly by the proprietary operating system of the automation equipment.

Only the application in object language (proprietary) had a size compatible with the memory resources of the automation equipment and an application in object language cannot be used on a programming station without firstly being decompiled by a decompiler corresponding to the proprietary language of the operating system. Therefore, it was not possible for a programming station without anything installed on it to be connected to automation equipment and to retrieve an automation application described in a graphic language. Thus, by combining the use of grammars in the XML language and compaction stylesheets, it is possible to generate one or several compacted files (501) describing the application that are sufficiently small so that they can be loaded onboard the automation equipment at the same size as the executable file (502). Each file (501) can be unloaded on a programming station to be decompressed and then used by any software using the XML language.

The compression program (60) does the compression in two steps are shown in FIG. 4:

a first step to reduce tags using a transformation mechanism (604) (XSLT (eXtensible Stylesheet Language Transformation) processor) to transform tags in the XML file (401) by applying a stylesheet in the XSL (eXtensible Stylesheet Language) standard to this XML file. This specific XSL stylesheet (601) created specially for the needs of the invention, is partially described as an example in Appendix 6. It is a means of reducing the length of tag names and therefore supplying a translation in reduced XML language for each tag in the XML file (401). The stylesheet is applied in the programming station and it provides a reduced XML file (602) at the output, temporarily stored so that it can subsequently be used by a compaction algorithm that is executed on the programming station. Appendix 4 contains an example of an XML file (401) and appendix 5 contains the same example in the form of a reduced XML file (602).

a second step in the execution of a compaction algorithm (603) like that in particular marketed under the term “Xmill”, adapted to documents in the XML language. This algorithm starts with the reduced XML file (602) and produces a compacted file (501). This type of compaction algorithm takes advantage of knowledge of rules of the XML language, particularly rules inherent to XML documents, and especially rules about tags (start tag, end tag, no nesting of tags) to optimise compression.

As mentioned above, appendix 6 only contains a fragment of a specific stylesheet (601) sufficient to understand the mechanism for reducing the size of tags in an XML file. Considering only a few examples chosen in the part shown in Appendix 6, the “company” tag will thus be reduced to tag “c1” (see page 27 lines 68-70) by application of the stylesheet. Similarly, the “dateTime” tag will be reduced to tag “d2” (see page 28 lines 37-39), the “address” tag will be reduced to tag “a2” (see page 29 lines 12-14), etc. Thus, all tags in an XML file can be reduced similarly to make it easy to optimise the size of a reduced XML file. For example in appendix 4, lines 10-11 of page 21 contain the “company” and “dateTime” tags that are reduced to tags “c1” and “d2” in appendix 5 on lines 8-9 in page 24. In these appendices 4 and 5, the position of the indent of an object from the beginning of the line defines the hierarchical dependence of this object.

Conversely, in an advantageous variant of the invention, the import routine comprises a decompression program (61) to generate a decompacted form of a description file (401) in the XML language, starting from a compacted XML file (501) stored in the memory (50) of the automation equipment. The decompression program (61) comprises a step to execute the decompaction algorithm (603) adapted to XML files to obtain a file in reduced XML format (602), then a step to recreate the source tags (Tags) using the transformation mechanism (604) by applying the stylesheet (601) to the reduced XML file (602).

The application stored in an XML description file (401) on the programming station is modelled by the XML handler Hndlr (20) in the form of a tree structure (30), using firstly information distributed in data bases (Db1, Db2, etc.) and in the form of a binary file in the memory of the programming station, and secondly indexes created by the GenInTag component (25) to access this information and to represent it in tree structure form. In the import direction, the tree structure is recreated from the XML source file (401) and XML grammar files (402). In the export direction, they are composed of XML grammar files. The XML handler Hndlr (20), as shown in FIG. 1, communicates with managers (Mng1, Mng2, etc.) of databases (Db1, Db2, etc.) and with the tree structure management module, through notifications.

Thus during an export, a manager (Mng1) can send a notification (102) “CreateNode (index, value)” requesting the XML handler Hndlr (20) to create a node with a determined index and a determined value. The XML handler Hndlr (20) uses index values and grammar files (402) to request the tree structure management module to create a node with tag name equal to the name defined by “tagname” and value equal to the value denoted by “value”, through a notification (203) “CreateNode (tagname, value)”. In the reverse direction, during the import, the manager (Mng1) requests the XML handler Hndlr (20) to send information to it about a node through a notification (201) “GetNode (index, value)”. The XML handler Hndlr (20) that receives this notification examines the index and the corresponding tag name (Tag) in the mapping tables consisting of the index files (I1 to I4). The XML handler Hndlr (20) then requests the tree structure management module to send it a notification (302) “GetNode (tagname, value)”.

The handler (20) thus defined is installed on a programming station, and consequently, it can be used with the XML language grammar files to describe an automation application that can very easily be edited since the XML description files of the application (401) thus obtained are in ASCII can be edited and modified using any text editor. This avoids having specific display programs to display graphic languages specific to automation applications.

Another advantage of the invention is that it can be used to operate old previously developed automation programs by converting (exporting) these programs formulated in databases (Db1, Db2, etc.) into XML files.

Finally, another advantage of the XML handler Hndlr (20) is that it can export a description file from an application developed in the XML language into an application using one of the graphic automation description languages (LD, SFC, FBD) used in the past.

The invention also relates to an automation equipment comprising a memory (50) containing the automation application program in the form of a binary file (502) that can be executed by the automation equipment. Starting from one or several description files (401) describing all or part of the application and expressed in a single, hierarchised and object oriented language, the automation equipment stores one or several files in compacted format (501) output from the description file(s) (401), in addition to the executable file (502), in the memory (50), the contents of this (these) file(s) remaining sufficient to describe part of the application considered. In the embodiment described, this single, hierarchised and object oriented language is for example the XML (eXtended Markup Language) language.

Advantageously, this type of automation equipment comprises translation means such as an interpreter module to convert description files (401) of the automation application stored in the XML language into a binary file (502) that can be executed by the automation equipment. The function of this interpreter module is to translate the instructions describing an automation application formulated in the XML language, into instructions that can be executed by the proprietary operating system of the automation equipment. In this way, the result is automation equipment for which the programming language would be accessible using any editor installed on a PC type machine so that the automation designer can thus develop application programs for which the files would be stored in ASCII, regardless of the manufacturer of the automation equipment and the operating system used, provided only that the automation equipment is provided with the interpreter module converting XML language into the proprietary binary language.

Furthermore, the automation equipment may also comprise decompression means so that a decompacted form of a description file (401) in the XML language can be generated starting from a compacted XML file (501) stored in the memory (50) of the automation equipment. In order to achieve this, the automation equipment executes a decompression program (61) like that described above. The decompression program (61) includes a step to execute a decompaction algorithm adapted to XML files, and then a step to recreate the source tags (Tags) by the application of a stylesheet (601). The decompression program (61) and the stylesheet (601) are stored in the memory (50) of the automation equipment.

In this way, a programming station without anything installed on it can be connected directly to automation equipment and can retrieve an automation application through description files in the XML language.

Graphic automation languages can thus be described in a standard manner in ASCII. Standardizing a grammar in this way enables an exchange of application programs between operating systems and programming workshops made by different manufacturers.

Since programming in XML is independent of a graphic technology and is independent of Microsoft Windows or any graphic library or even a graphic format (JPEG, BMP, etc.) the invention can be used to generate standard application programs that can be installed on the different platforms. The invention thus enables XML generators to automatically generate automation application programs.

Finally, the invention facilitates the exchange of data in the form of XML files with CAD and Supervision software.

It will be obvious to experts in the subject that this invention can be used in many other specific embodiments without departing from the scope of the invention as claimed; Consequently, the embodiments given herein must be considered as illustrations but may be modified within the domain defined by the scope of the appended claims.

[image]

[image]

[image]

[image]

[image]

[image]

[image]

[image]

[image]

[image]

[image]

[image]

[image]

[image]

[image]

[image]

[image]

[image]

1. Programming station for an automation application designed to be executed in an automation equipment, the programming station comprising a memory containing a set of one or several description files (401), each description file describing part of the automation application and being expressed in a single, hierarchised and object oriented language, characterised in that the programming station uses a compression program (60) that generates a file in the compacted format (501) for each description file, the contents of the compacted file being sufficient for the description of part of the application considered, and in that it uses a loading program to store each compacted file (501) in a memory (50) in the automation equipment.

2. Programming station according to claim 1, characterised in that it uses a decompression program (61) to generate a description file (401) in a single, hierarchised and object oriented language describing part of the application, from a compacted file (501) stored in the automation equipment memory (50).

3. Programming station according to claim 2, characterised in that the single, hierarchised and object oriented language is the XML language.

4. Programming station according to one of claims 1 to 3, characterised in that the set of description files (401) contains an application program description file, an application input-output description file, and an application data description file.

5. Programming station according claim 3, characterised in that the compression program (60) and the decompression program (61) comprise two steps.

6. Programming station according to claim 3, characterised in that the compression program (60) comprises a step to reduce the tags contained in a description file (401) expressed in the XML language by application of a specific stylesheet (601) and a step to execute a compaction algorithm (603) adapted to XML files.

7. Programming station according to claim 3, characterised in that the decompression program (61) comprises a step to execute a decompaction algorithm (603) adapted to XML files and a step to recreate source tags contained in a description file (401) expressed in the XML language, by application of a specific stylesheet (601).

8. Programming station according to one of the previous claims, characterised in that it includes an XML handler (20) in a non-volatile memory dialoguing through notifications firstly with a management module (30) of the tree structure representative of the automation application expressed in the XML language, and also with a plurality of database managers (Mng1, Mng2, etc.), each manager being specific to part of the automation application stored in one of the databases (Db1, Db2, etc.).

9. Automation equipment comprising a memory (50) containing an automation application program in the form of a binary file (502) executable by the automation equipment, characterised in that the automation equipment stores the executable file (502) in its memory, together with one or several files (501) in compacted format output from a set of one or more description file(s) (401) describing the automation application and expressed in a single, hierarchised and object oriented language.

10. Automation equipment according to claim 9, characterised in that the single, hierarchised and object oriented language is the XML language.

11. Automation equipment according to claim 10, characterised in that it comprises translation means in order to convert application description files (401) expressed in the XML language into a binary file (502) that can be executed by the automation equipment.

12. Automation equipment according to claim 10 or 11, characterised in that it comprises means of decompressing a file in the compacted language (501) to a description file in XML language (401) by using a specific stylesheet (601) stored in memory (50).
